(19) United States
(12) Patent Application Publication
(10) Pub. No.: US 2022/0005116 A1
(43) Pub. Date: Jan. 6, 2022

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Masahiro YAMADA, Kanagawa (JP)

(73) Assignee: FUJIFILM Business Innovation Corp., Tokyo (JP)

(21) Appl. No.: 17/225,112

(22) Filed: Apr. 8, 2021

(30) Foreign Application Priority Data
Jul. 2, 2020 (JP) 2020-114905

(51) Int. Cl. G06Q 40/02

(52) U.S. Cl. CPC G06Q 40/025

(57) ABSTRACT

An information processing apparatus includes a processor configured to return a content to a lender of the content when an end of an operation related to the content lent to a lending destination is detected.

### CROSS-REFERENCE TO RELATED APPLICATIONS

This application is based on and claims priority under 35 USC 119 from Japanese Patent Application No. 2020-114905 filed Jul. 2, 2020.

### BACKGROUND

### (i) Technical Field

The present disclosure relates to an information processing apparatus and a non-transitory computer readable medium.

### (ii) Related Art

Techniques are available for one user to allow another user to use a content. For example, in one technique, the other user is allowed to use a content by transferring a content usage right among users from one user to another in accordance with a floating license.

If a user holding a content, such as software, lends another user the content with a time limit, the user as a lending destination of the content may use the content within the time limit but is obliged to return the content later. The content is returned at the end of a lending period.

For more information, reference is made to Japanese Unexamined Patent Application Publication Nos. 2006-216041, 2013-114371, and 2006-235757.

### SUMMARY

Aspects of non-limiting embodiments of the present disclosure relate to returning a content relatively rapidly from a lending destination to a lender in accordance with a lending period when the content is used.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to return a content to a lender of the content when an end of an operation related to the content lent to a lending destination is detected.

### BRIEF DESCRIPTION OF THE DRAWINGS

Exemplary embodiment of the present disclosure will be described in detail based on the following figures, wherein:

FIG. 1 illustrates a computer system of an exemplary embodiment of the disclosure;

FIG. 2A illustrates an example of a lending screen displayed on a user terminal apparatus of a lender when a function is lent in accordance with the exemplary embodiment and FIG. 2B illustrates an example of a lending notification screen displayed on a user terminal apparatus of a lending destination when the function is lent in accordance with the exemplary embodiment;

FIG. 3A illustrates an example of a returning notification screen displayed on the user terminal apparatus of the lender when the function is returned in accordance with the exemplary embodiment and FIG. 3B illustrates an example of a returning screen displayed on the user terminal apparatus of the lending destination when the function is returned in accordance with the exemplary embodiment;

FIG. 4 is a flowchart illustrating a process of the user terminal apparatus of the lending destination in accordance with the exemplary embodiment;

FIG. 5 illustrates another example of the lending screen in accordance with the exemplary embodiment;

FIG. 6 illustrates another example of the lending screen in accordance with the exemplary embodiment;

FIG. 7A illustrates another example of the lending screen displayed on the user terminal apparatus of the lender when the function is lent in accordance with the exemplary embodiment and FIG. 7B illustrates another example of the lending notification screen displayed on the user terminal apparatus of the lending destination when the function is lent in accordance with the exemplary embodiment;

FIG. 8A illustrates an example of a lending setting modification screen displayed on the user terminal apparatus of the lender when a setting of a lending condition is modified in accordance with the exemplary embodiment after the function is lent and FIG. 8B illustrates an example of a modification notification screen displayed on the user terminal apparatus of the lending destination when the setting of the lending condition is modified in accordance with the exemplary embodiment after the function is lent;

FIG. 9A illustrates an example of a setting modification request notification screen displayed on the user terminal apparatus of the lender when a setting of a lending condition is modified in accordance with the exemplary embodiment after the function is lent, FIG. 9B illustrates an example of a setting modification request screen displayed on the user terminal of the lending destination when the setting of the lending condition is modified in accordance with the exemplary embodiment after the function is lent, and FIG. 9C illustrates a portion of a reply display screen displayed on the user terminal apparatus of the lending destination that displays the intension of the lender on the user terminal apparatus of the lending destination;

FIGS. 10A and 10B illustrate an example of lending suspension screens respectively displayed on the user terminal apparatus of the lender when the lending is suspended in accordance with the exemplary embodiment after the function is lent;

FIG. 11 illustrates an example of an automatic returning notification screen displayed on the user terminal apparatus of the lender when an automatic returning of the function is performed in accordance with the exemplary embodiment;

FIG. 12A illustrates another example of the returning notification screen displayed on the user terminal apparatus of the lender when the function is returned in accordance with the exemplary embodiment and FIG. 12B illustrates another example of the returning screen displayed on the user terminal apparatus of the lending destination when the function is returned in accordance with the exemplary embodiment;

FIG. 13 illustrates another example of the lending notification screen displayed on the user terminal apparatus of the lending destination when the function is lent in accordance with the exemplary embodiment;

FIG. 14A illustrates an example of a notification screen displayed on the user terminal apparatus of the lender in accordance with the exemplary embodiment when the lending destination places a request to make the function persistent, FIG. 14B illustrates an example of a persistence request screen displayed on the user terminal apparatus of the lending destination in accordance with the exemplary embodiment when the lending destination places the request to make the function persistent, and FIG. 14C illustrates an example of a reply display screen that displays the intension of the lender on the user terminal apparatus of the lending destination in accordance with the exemplary embodiment; and

FIG. 15A illustrates another example of the notification screen displayed on the user terminal apparatus of the lender when the lending destination places the request to make the function persistent in accordance with the exemplary embodiment, FIG. 15B illustrates another example of the persistence request screen displayed on the user terminal apparatus of the lending destination in accordance with the exemplary embodiment when the lending destination places the request to make the function persistent in accordance with the exemplary embodiment, and FIG. 15C illustrates another example of the reply display screen that displays the intension of the lender on the user terminal apparatus of the lending destination in accordance with the exemplary embodiment.

### DETAILED DESCRIPTION

Exemplary embodiment is described with reference to the drawings.

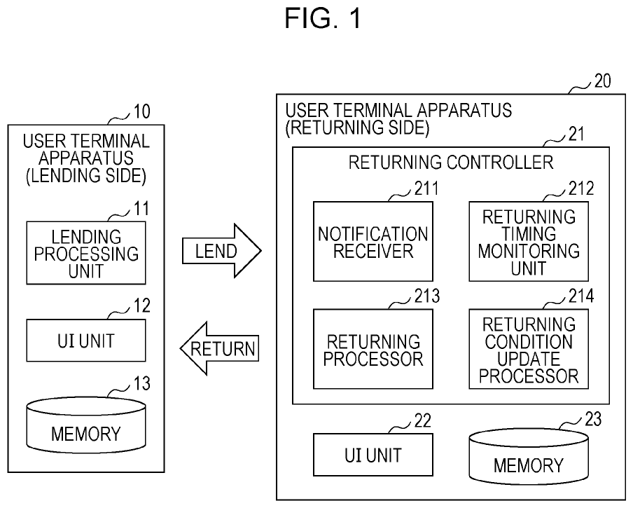

FIG. 1 illustrates a computer system including two user terminal apparatuses 10 and 20. The exemplary embodiment is related to a system in which a user allows another user to use a content by temporarily lending the content to the other user and the lent content is then returned the user by the other user. The user terminal apparatus 10 is a terminal apparatus that is used by the user on the content lending side (hereinafter referred to as a lender). The user terminal apparatus 20 is a terminal apparatus that is used by a user who is on the lending destination side and returns the lent content (hereinafter referred to as a lending destination). The user terminal apparatuses 10 and 20 are connected for communications to other terminal apparatuses 10 and 20 via a communication network. The type of the communication network is not limited to any type. The communication network may be a wide-area network, such as the Internet, or a narrow-area network, such as local area network (LAN). The communication network may also be a wired or wireless network.

The user terminal apparatuses 10 and 20 are implemented by a versatile hardware configuration available in the related art, such as a personal computer (PC).

Specifically, each of the user terminal apparatuses 10 and 20 includes a processor, memory unit, such as read-only memory (ROM), random-access memory (RAM), or hard disk drive (HDD), input unit, such as a mouse or keyboard, user interface having a display, and network interface to communicate with the other user terminal apparatuses 20 and 10.

The user terminal apparatus 10 used by the user as a lender of a content includes a lending processing unit 11, user interface (UI) unit 12, and memory 13. Elements not described with reference to the exemplary embodiment are not illustrated in the drawings. The lending processing unit 11 performs a lend process described in detail below. The UI unit 12 receives a detail input and specified on a display screen by a user and performs display control on a variety of screens. The memory 13 stores a content serving as a lending target and a file used when the content is used. The lending processing unit 11 and the UI unit 12 in the user terminal apparatus 10 are implemented when the computer forming the user terminal apparatus 10 cooperates with a program that runs on a processor mounted on the computer. The memory 13 is also implemented by the HDD mounted on the user terminal apparatus 10. Alternatively, the memory 13 may be a RAM or an external memory that is connected via a network.

The user terminal apparatus 20 used by the lending destination user of a content includes a returning controller 21, UI unit 22, and memory 23. Elements not described with reference to the exemplary embodiment are not illustrated in the drawings. The returning controller 21 performs a process from receiving a lent content to returning the lent content and performs control for the process. The UI unit 22 receives a detail input and specified on a display screen by the user and performs display control on a variety of screens. The memory 23 stores a lent content, a lending condition and file received together with the content, and a file produced as a result of executing the content.

The returning controller 21 includes a notification receiver 211, returning timing monitoring unit 212, returning processor 213, and returning condition update processor 214. The notification receiver 211 receives a variety of notifications from the user terminal apparatus 10. The returning timing monitoring unit 212 monitors the operation related to the content and in particular detects the end of the operation related to the content. The returning processor 213 performs a returning operation on the lent content. The memory 23 stores a lending condition acquired from the user terminal apparatus 10 as a returning condition of the content. The returning condition update processor 214 modifies a setting detail of the returning condition in response to an instruction from a user as a lender (lender user) or when the lender user responds to a setting modification request from a user as a lending destination (lending destination user).

The returning controller 21 and UI unit 22 in the user terminal apparatus 20 are implemented when a computer forming the user terminal apparatus 20 cooperates with a program running on a processor mounted on the computer. The memory 23 may be implemented by a storage unit, such as a hard disk drive (HDD) mounted on the user terminal apparatus 20. Alternatively, the memory 23 may be a RAM or an external storage unit connected via a network.

The program of the exemplary embodiment may be provided via a communication medium or in a storage form on a computer readable medium, such as a compact disk read-only memory (CD-ROM) or a universal serial bus (USB) memory. The program provided via the communication medium or the recording medium is installed on the computer and a variety of processes are implemented when a central processing unit (CPU) on the computer executes the program.

The “content” in the exemplary embodiment is not a tangible entity but an intangible entity, such as software or data, which is exchangeable via a communication network. Although a content may be lent to multiple users, one user is a lending destination of the content in accordance with the exemplary embodiment. When the content is lent to a user, the lent content is handled as the content that is at the lending destination, and the lender user is unable to lend the lent content to another user. Unless specifically noted, even the lender user is unable to perform the operation related to the lent content.

According to the exemplary embodiment, a function that is performed when a task is performed is a content as described below. The function is an example of the content forming a task. The function in the exemplary embodiment is implemented when a program is executed. According to the exemplary embodiment, the program to implement each function forming a task is simply referred to as a “function.” According to the exemplary embodiment, the program is described as a content, but the content is not limited to a program. For example, the content may be data, such as a document or image, used in the task.

The “operation related to the content” refers to an operation that is performed when a function, such as software like a program, is performed. If the content is data, the operation related to the content refers to an operation performed by using data. The operation related to the content includes an operation that is performed by performing the content and an operation that is performed by using the content.

According to the exemplary embodiment, the user as the content lender (for example, a user A) performs a task by using the user terminal apparatus 10. The task may be performed by using a single function. According to the exemplary embodiment, however, the task is typically performed by using multiple functions. Specifically, the task is complete by performing all multiple functions forming the task. When the task is performed, the user A may perform all the functions forming the task by not using the user terminal apparatus 10 but by lending all or some of the functions forming the task to another user. The user serving as a function lending destination (for example, a user B) performs one function or multiple functions by using the user terminal apparatus 20. The user A sets a lending condition when a function is lent to the user B. The user B returns the lent function with the lending condition as a returning condition when an event meeting the returning condition has occurred.

The process of the exemplary embodiment is described below. According to the exemplary embodiment, the user as the function lender is the user A and the user as the function lending destination is the user B.

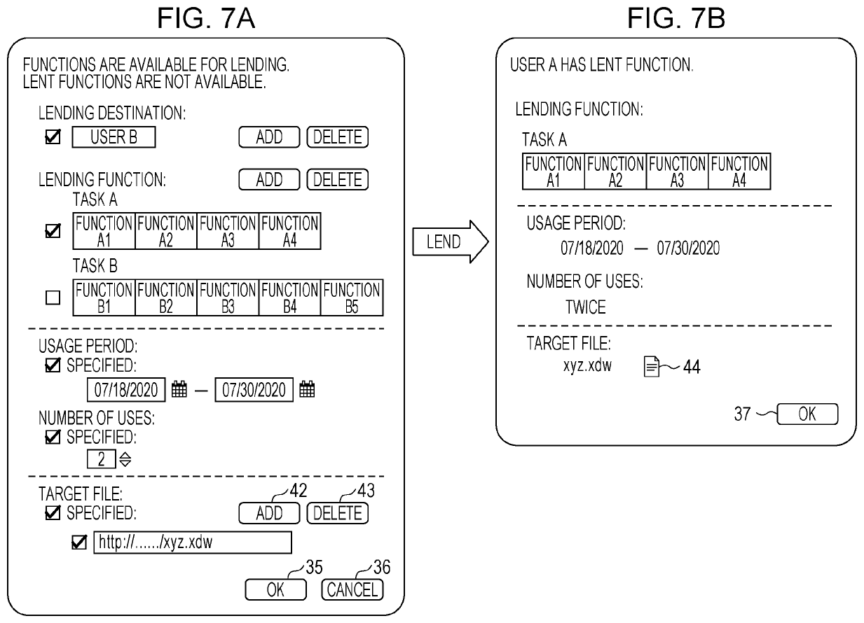

The user A sets a lending condition when he or she lends the user B a function. This is described more in detail below. The lending condition includes settings concerning a lending destination indicating who the function is lent to and a lending function indicating what function is lent. The lending condition additionally includes settings concerning an usage period of the function and the number of permissible uses as illustrated in FIGS. 7A and 7B. In response to an operation instruction from the user A, the user terminal apparatus 10 notifies the user B that the function is going to be lent. Along with the notification, the user terminal apparatus 10 transmits to the user terminal apparatus 20 the lending condition set by the user A.

According to the exemplary embodiment, the lending of a function means to set to be accessible to the function for use the user B who has been originally inaccessible to the function as a lending target. As previously described, the user A is unable to use the function once lent via the lending operation. Afterwards, the user B is to return the lent function to the user A. After the returning, the user B is unable to use the function any longer. To lend the function, the user A is to transfer the function as the lending target to the user B. The function is transferred via one of the following methods.

If the function is stored on the memory 13, the user terminal apparatus 10 retrieves the function together with the notification from the memory 13 and transmits the function and notification. If a function lending service is implemented by a cloud (not illustrated), the user terminal apparatus 10 requests the lending service to transmit the function as the lending target to the user terminal apparatus 20. If the user terminal apparatus 20 has the function as the lending target but the use of the function is restricted, the user terminal apparatus 10 cancels the usage restriction of the function such that the user terminal apparatus 20 may use the function in response to the lending of the function. If the function is managed over the cloud (not illustrated), the user who is eligible to use the function is switched from the user A to the user B within the cloud. According to the exemplary embodiment, the function to be lent to the user B is stored on the memory 13 as described first herein.

As described below, the function is lent from the lender to the lending destination and the lent function is to be returned to the lender. Only a single user may hold and use the lend function. If the corresponding function remains on the user terminal apparatus 10, control is performed such that the corresponding function is not performed on the user terminal apparatus 10 during the lending period.

A basic process of the exemplary embodiment from lending the function from the user A to the user B to returning the function from the user B to the user A is described.

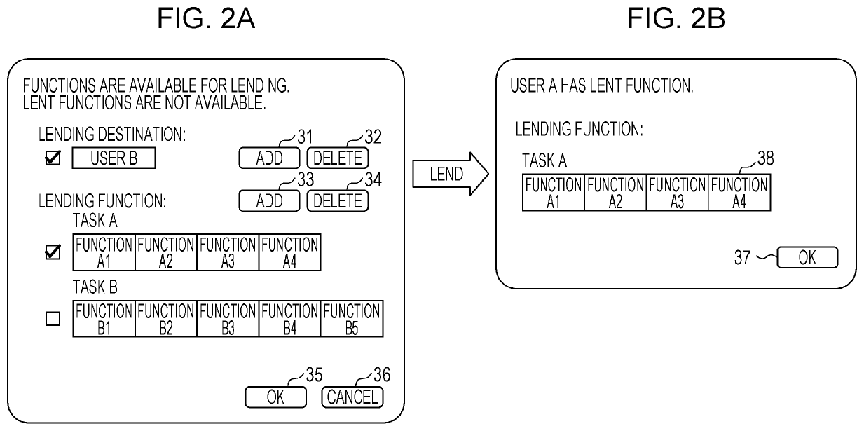

FIG. 2 illustrates an example of screens respectively displayed on the user terminal apparatuses 10 and 20 when the lending is performed. When the user A performs a predetermined operation on the user terminal apparatus 10, the UI unit 12 displays a lending screen in FIG. 2A in response to the predetermined operation. The user A selects on the lending screen in FIG. 2A a user serving a lending destination and a lending function by checking check boxes corresponding to the user and the lending function. As illustrated in FIG. 2A, the user B is selected as a lending destination and all functions A1 through A4 forming a task A are selected.

Referring to FIG. 2A, only the user B is registered in a lending destination list. Another user may be added to the lending destination list by specifying that user with an add button 31 selected. Conversely, a user may be deleted from the lending destination list by selecting a delete button 32 with the user in the lending destination list specified.

Referring to FIG. 2A, tasks A and B are registered in a lending function list. A task serving as a lending target may be added to or deleted from the lending function list by using an add button 33 and delete button 34.

When the user A selects an OK button 35 after selecting the lending destination and the lending function, the user terminal apparatus 10 transmits a notification of lending the function to the user terminal apparatus 20 used by the user B. The function as a lending target and lending condition are attached to the notification. According to the exemplary embodiment, the lent function may be appropriately deleted from the memory 13. When the lending is suspended, the user A may select a cancel button 36. If the cancel button 36 is selected in an operation to operate the screen as described below, that operation is also suspended. The description of the cancel button 36 is not repeated.

When the notification receiver 211 in the returning controller 21 of the user terminal apparatus 20 receives the notification of lending the function from the user terminal apparatus 10, the UI unit 22 displays a lending notification screen in FIG. 2B in response to an instruction from the returning controller 21. The lending notification screen may be a popup screen.

By referencing the lending notification screen in FIG. 2B, the user B may learn that the functions are lent by the user A. The user B may also learn that the lent functions are functions A1 through A4 forming a task A. The user B may erase the popup screen by selecting an OK button 37. Although the exemplary embodiment assumes that the lending is accepted, a user interface to reject the lending, such as a reject button to reject the function lending, may be arranged on the screen.

When the user B selects the OK button 37, the returning controller 21 stores the function received together with the notification on the memory 23 and further stores on the memory 23 the lending condition received together with the function as the returning condition. The timing of the storage on the memory 23 may be triggered by not the operation of the OK button 37 but by the reception of the notification from the user terminal apparatus 10.

The screen is displayed in response to a notation from the other user terminal apparatuses 10 and 20. Specifically, in the same way as described with reference to FIG. 2B, a variety of notification screens are displayed as a popup screen and is deleted in response to the operation of the OK button. In the discussion that follows, the discussion of the screen display responsive to the notification and the screen deletion responsive to the operation of the OK button may be omitted as appropriate.

The user B executes thus lent functions A1 through A4. Buttons 38 corresponding to the functions A1 through A4 may be displayed on the screen such that the user B may select each of the functions A1 through A4. Alternatively, the functions A1 through A4 stored on the memory 23 may be selected by the user B. The execution method of each function is not limited to any method.

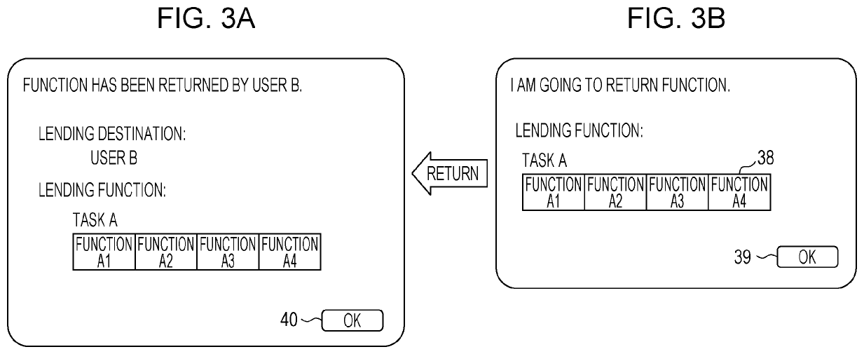

FIGS. 3A and 3B illustrate an example of screens respectively displayed on the user terminal apparatuses 10 and 20 when the function is returned. To return the functions A1 through A4 after the user B has performed all the lent functions A1 through A4, a predetermined operation is performed on the user terminal apparatus 20. When the end of the execution of the functions A1 through A4 is detected in response to the predetermined operation of the user B, the returning processor 213 causes the UI unit 22 to display a returning screen in FIG. 3B. The user B selects an OK button 39 on the returning screen in FIG. 3B after verifying the functions A1 through A4 as returning targets. In response to the selection operation, the returning processor 213 transmits a notification indicating the returning of the function to the user terminal apparatus 10 used by the user A as the lender. The lent functions A1 through A4 are attached to the notification and thus returned.

When the user terminal apparatus 10 has received the notification indicating the returning of the function from the user terminal apparatus 20, the lending processing unit 11 displays a returning notification screen in FIG. 3A on the UI unit 12. The user A thus learns that the lent functions A1 through A4 have been returned.

When the user A selects an OK button 40, the lending processing unit 11 stores the functions A1 through A4 received together with the notification on the memory 13. The timing of the storage on the memory 13 may be a timing when the notification is received. Product, such as a file, created when the functions A1 through A4 are executed may be obtained together with the functions A1 through A4 from the user terminal apparatus 20.

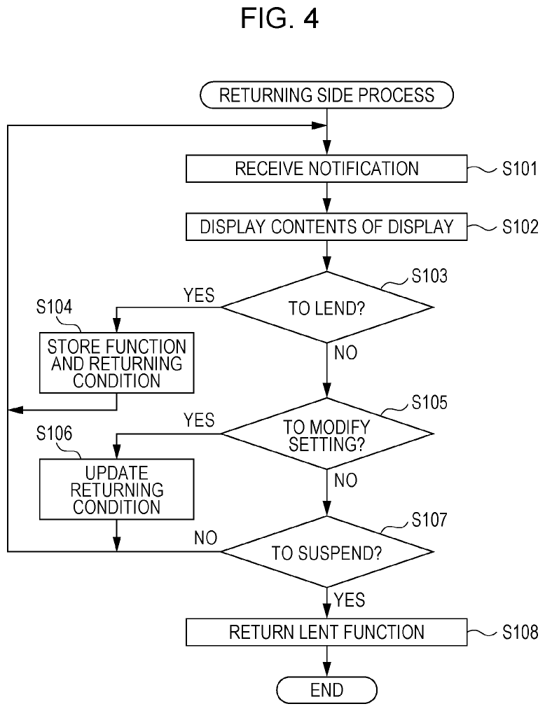

The basic process relating to the lending and returning of the function in the exemplary embodiment has been described. The process of the user terminal apparatus 20 performed at the lending of the function is described with reference to the flowchart in FIG. 4.

The notification receiver 211 in the returning controller 21 of the user terminal apparatus 20 waits on standby for any notification coming in from the user terminal apparatus 10. When the notification receiver 211 receives the notification of the lending of the function from the user terminal apparatus 10 (step S101), the UI unit 22 displays the detail of the notification on a predetermined screen in response to an instruction from the returning controller 21 (step S102). Since the detail of the notification is the notification of lending the function, the UI unit 22 displays the lending notification screen in FIG. 2B. If the notification indicates the lending of the function (yes in step S103), the returning controller 21 stores on the memory 23 the function received together with the notification and the lending condition as the returning condition of the function (step S104). Other steps in FIG. 4 are described below.

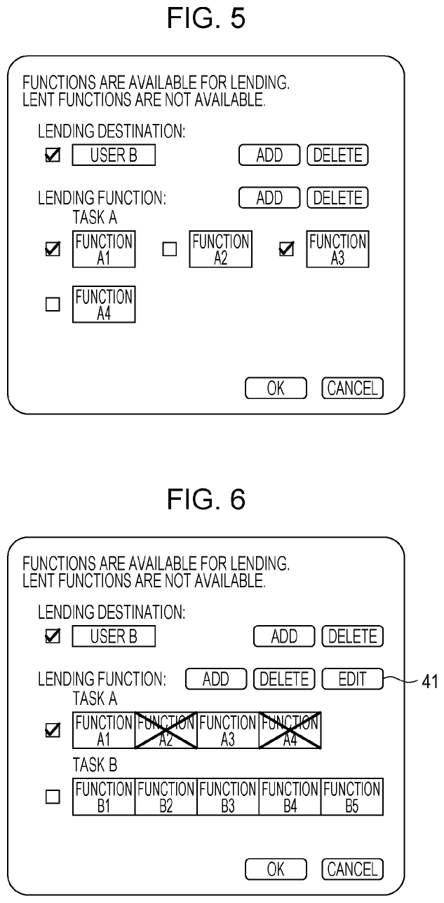

FIGS. 5 and 6 illustrate other examples of the lending screen and correspond to FIG. 2A. Referring to FIGS. 2A and 2B, the function is lent on a per task basis, and FIGS. 5 and 6 illustrate an interface that allows the task to be lent on a per function basis. Referring to FIG. 5, one check box corresponds to one function. The user A checks a check box corresponding to a function to be lent on the lending screen in FIG. 5. FIG. 5 illustrates an example in which the functions A1 and A3 are set to be lending targets.

Referring to FIG. 6, an edit button 41 is added in FIG. 2A. If the user A has selected the edit button 41, a function serving as a nonlending target may be marked with a symbol (such as “x” in FIG. 6). The user A thus marks the function serving as a nonlending target with the symbol x. Referring to FIG. 6, the check box corresponding to a task A is checked. The functions A2 and A4 that are nonlending targets are marked with nonlending target symbols and the functions A1 and A3 from among the functions A1 through A4 included in the task A are set to be lending targets.

In the previous discussion, the process with the additional lending condition not set in the lending of the function is described with reference to FIGS. 2A and 2B. The process with the additional lending condition set by the user A is described below. The process other than the setting of the additional lending condition remains identical to the process described with reference to FIGS. 2A and 2B and the description common to the two processes is appropriately omitted.

FIGS. 7A and 7B correspond to FIGS. 2A and 2B and illustrate another example of screens respectively displayed on the user terminal apparatuses 10 and 20 when the function is lent. When the user A performs a predetermined operation on the user terminal apparatus 10, the UI unit 12 displays a lending screen in FIG. 7A in response to the predetermined operation. The user A sets a lending destination and a lending function on the lending screen in FIG. 7A. The user A further sets an additional lending condition. FIG. 7A illustrates the example of the lending screen that allows an usage period, number of uses, and target file to be set in the lending conditions. To set the lending conditions, a check box corresponding to the lending condition is checked. Referring to FIG. 7A, all the lending conditions of the usage period, number of uses, and target file are set.

The usage period defines the lending period of a function and is set with a start time and an end time. The number of uses is the number of uses by which the use of the function can be repeated. Since the number of uses is twice in FIG. 7A, the lending condition is that each of the functions A1 through A4 as a lending target is usable twice. The number of uses may be set on a per function basis. The target file is processed by the function as a lending target. The function may process only the target file as a process target or as a portion of the process target. According to the exemplary embodiment, a content to be lent is set via a lending function and a file to be set as the target file does not correspond to the content to be lent. A target file may be added by operating an add button 42.

Referring to FIG. 7A, only “xyz.xdw” is registered in a target file list. A file may be added in the target file list by specifying the file with the add button 42 selected. Conversely, a file may be deleted from the target file list by selecting a delete button 43 with the file listed in the target file list.

When the OK button 35 is selected after the user A sets the lending condition, the user terminal apparatus 10 transmits the notification of lending the function to the user terminal apparatus 20 used by the user B as a lending destination. The function as the lending target and the lending condition are attached to the notification. If the target file is set in the lending condition, storage destination information identifying a storage destination of the target file is attached to the notification. If the target file is stored on the memory 13, the target file may be transmitted together with the notification to the user terminal apparatus 20.

If the notification receiver 211 in the returning controller 21 of the user terminal apparatus 20 receives the notification of lending the function from the user terminal apparatus 10, the UI unit 22 displays a lending notification screen in FIG. 7B in response to an instruction from the returning controller 21.

By referencing the lending notification screen in FIG. 7B, the user B may learn that the user A has lent the functions A1 through A4 forming the task A. The user B learns the usage period and the number of uses. The user B also learns the presence of the target file. If the user B selects an icon 44 attached the target file, the returning controller 21 may retrieve the target file from the storage destination and may store the target file on a predetermined storage destination (for example, the memory 23) or a storage destination particularly specified by the user B. The operation related to the icon 44 attached to the target file remains the same in the discussion below on the operation of the screen and the description of the operation is omitted as appropriate.

If the user B selects the OK button 37, the returning controller 21 stores the function received together with the notification on the memory 23 while storing at the same time on the memory 23 the lending condition received together with the function as the returning condition of the function. The timing of the storage on the memory 23 may be triggered by not the timing of the operation on the OK button 37 but by the reception of the notification from the user terminal apparatus 10.

The user A sets the lending condition in this way. The user A may modify the set lending condition after lending by arranging the returning condition update processor 214.

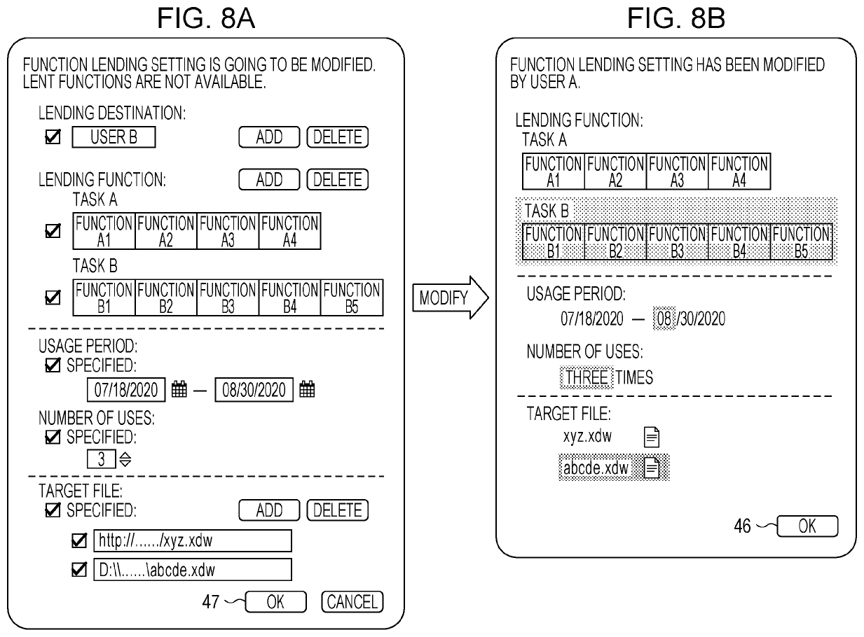

FIGS. 8A and 8B illustrate an example of screens respectively displayed on the user terminal apparatuses 10 and 20 when the setting of the lending condition is modified after the function is lent. FIGS. 8A and 8B illustrate the example when the lending condition set on the lending screen in FIG. 7A is modified.

The user A may now wish to modify the set lending condition. When a predetermined operation is performed on the user terminal apparatus 10, the lending processing unit 11 causes the UI unit 12 to display a lending setting modification screen in FIG. 8A. The lending setting modification screen displays the set lending condition. The user A modifies the lending condition on the lending setting modification screen. Referring to FIG. 8A, all functions B1 through B5 included in a transaction B as lending functions are added, the usage period extended, the number of uses is increased to three times, and “abcde.xdw” is added as a target file.

When the user A selects an OK button 45 with the setting of the lending condition modified, the user terminal apparatus 10 transmits the notification of modifying the setting of the lending condition to the user terminal apparatus 20 used by the user B as the lending destination. The lending condition and information identifying a portion of the lending condition modified in accordance with this setting modification are attached to the notification.

When the notification receiver 211 in the returning controller 21 of the user terminal apparatus 20 receives the notification of modifying the setting of the lending condition from the user terminal apparatus 10, the UI unit 22 displays a modification notification screen in FIG. 8B in response to an instruction from the returning condition update processor 214.

In a way different from the screen in FIG. 7B, the screen in FIG. 8B clearly indicates portions of the lending condition modified in accordance with this setting modification. Referring to FIG. 8B, the modified portions are labeled with a pattern. The exemplary embodiment is not limited to this pattern labeling. For example, the modified portion may be displayed in a display attribute, such as a display color, different from the display color of the unmodified portion of the lending condition.

When the user B selects the OK button 45 and the function is received together with the notification, the returning controller 21 stores the function on the memory 23 while storing on the memory 23 the modified lending condition as the returning condition in association with the function. The timing of the storage on the memory 23 may be triggered by the reception of the notification from the user terminal apparatus 10.

The process of the user terminal apparatus 20 related to the setting modification of the lending condition described above is described with reference to the flowchart in FIG. 4.

If the notification receiver 211 receives the notification of modifying the setting of the lending condition from the user terminal apparatus 10 (step S101), the UI unit 22 displays the notified detail on a specific screen in response to an instruction from the returning controller 21 (step S102). The modification notification screen in FIG. 8B is herein displayed. If the notification indicates the modification of the setting of the lending condition (no path in step S103 and yes path in step S105), the returning controller 21 stores the information received together with the notification on the memory 23. Specifically, if the function is added, the returning controller 21 stores on the memory 23 that function and the lending condition after the setting modification as the returning condition (step S106).

The description of the setting modification of the lending condition with reference to FIGS. 8A and 8B is applicable to when the user A modifies the setting of the lending condition. According to the exemplary embodiment, the user B may request the user A to modify the setting of the lending condition.

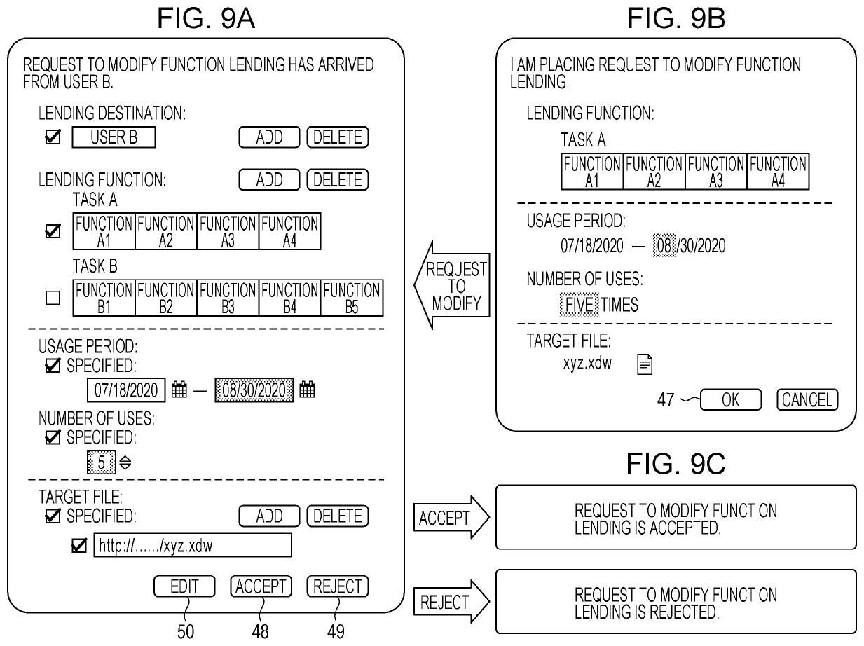

FIGS. 9A through 9C illustrate an example of screens respectively displayed on the user terminal apparatuses 10 and 20 when the user B requests the user A to modify the setting of the lending condition. Referring to a setting modification request screen in FIG. 9B, the user B is now requesting the user A to modify the end of the usage period and the number of uses. Referring to FIG. 9B, portions of the lending condition requested to be modified are labeled with a pattern. The exemplary embodiment is not limited to this pattern labeling. For example, the modified portion may be displayed in a display attribute, such as a display color, different from the display color of the unmodified portion of the lending condition. When the user B selects an OK button 47, the returning controller 21 transmits the notification of requesting to modify the setting of the lending condition to the user terminal apparatus 10 in response to the selection operation. The lending condition and the detail of the lending condition as a modification request target are attached to the notification.

When the notification of requesting to modify the setting of the lending condition is received, the lending processing unit 11 displays a setting modification request notification screen in FIG. 9A on the UI unit 12. The setting modification request notification screen displays the lending condition serving as a setting modification request target labeled with a pattern. The user A may more easily learn the lending condition that the user B may wish to modify. The exemplary embodiment is not limited to this example. Instead of using the pattern, the setting modification request notification screen may be in a display attribute, such as a display color, different from the display color of the lending condition that is not the modification request target.

To accept the modification request from the user B, the user A selects an accept button 48. To reject the modification request from the user B, the user A selects a reject button 49. When one of the buttons 48 and 49 is selected, the lending processing unit 11 notifies the user terminal apparatus 20 of the selected intention of the user A. Upon receiving the notification indicating the intention of the user A, the returning controller 21 displays the intention of the user A responsive to the setting modification request on the UI unit 22 as illustrated in FIG. 8C.

To further modify the setting in response to the setting modification request from the user B, the user A selects an edit button 50. In such a case, processing proceeds to the process described with reference to FIGS. 8A and 8B.

As described above, according to the exemplary embodiment, the detail of the operation related to the content, namely, the configuration of the function to be lent and the lending condition may be modified in response to the setting modification request from the lender of the function or the setting modification request from the lending destination to the lender.

The lending destination of the function may be modified as previously described. The user A may suspend the lending of the function after the lending.

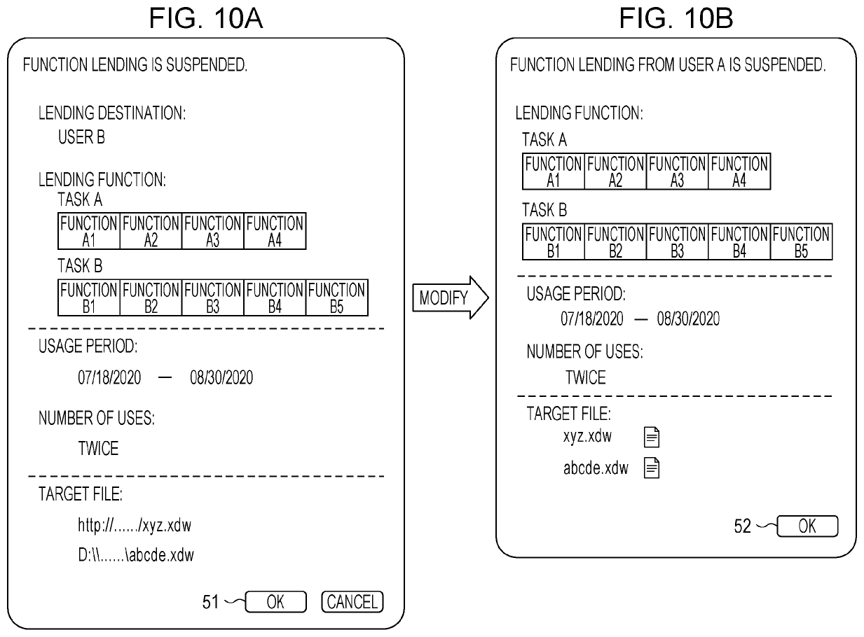

FIGS. 10A and 10B illustrate an example of screens respectively displayed on the user terminal apparatuses 10 and 20 when the lending of the function is suspended. A lending suspension screen in FIG. 10A displays lent detail. If the user A selects an OK button 51 on the lending suspension screen, the user terminal apparatus 10 transmits the notification of suspending the lending of the function to the user terminal apparatus 20 used by the user B. The lending condition is attached to the notification.

When the notification receiver 211 in the returning controller 21 of the user terminal apparatus 20 receives the notification of suspending the lending of the function from the user terminal apparatus 10, the UI unit 22 displays a suspension notification screen in FIG. 10B in response to an instruction from the returning controller 21. The suspension notification screen displays the lending condition related to the function that is a suspension target. If the user B selects an OK button 52, the returning processor 213 retrieves the function from the memory 23 and transmits the function to the user terminal apparatus 10 to return the function to the user A. The returning processor 213 deletes data related to the function as the suspension target from the memory 23.

The process of the user terminal apparatus 20 related to the suspension of the function described above is described with reference to the flowchart in FIG. 4.

When the notification receiver 211 receives the notification of suspending the lending of the function from the user terminal apparatus 10 (step S101), the UI unit 22 displays the detail of the notification on the predetermined screen in response to an instruction from the returning controller 21 (step S102). The suspension notification screen in FIG. 10B is thus displayed. If the notification indicates the suspension of the lending of the function (no path in step S103, no path in step S105, and yes path in step S107), the returning processor 213 returns the lent function to the user A (step S108).

The user terminal apparatus 20 returns the function basically when the end of the execution of all the lent functions is detected. If a request to suspend the lending is received from the lender, the functions may be returned regardless of whether the end of the execution of all the lent functions is detected.

The returning of the function performed by the user terminal apparatus 20 is described below.

Multiple functions are returned in bulk in the exemplary embodiment. For example, the returning processor 213 may return basically all the functions after all the functions are executed. However, a variety of timings of returning the function are contemplated. Specifically, the returning of the function may be performed automatically or manually, namely, in response to an operation of the user B.

The number of uses may be set in the lending condition, in other words, in the returning condition of the function. If the number of uses reaches the number of specified uses, the user terminal apparatus 20 does not allow the function to be executed any more. Similarly, if the present time reaches the end of the usage period, the user terminal apparatus 20 does not allow the function to be executed any more. When an event matching the returning condition is detected, the returning processor 213 automatically performs the function returning.

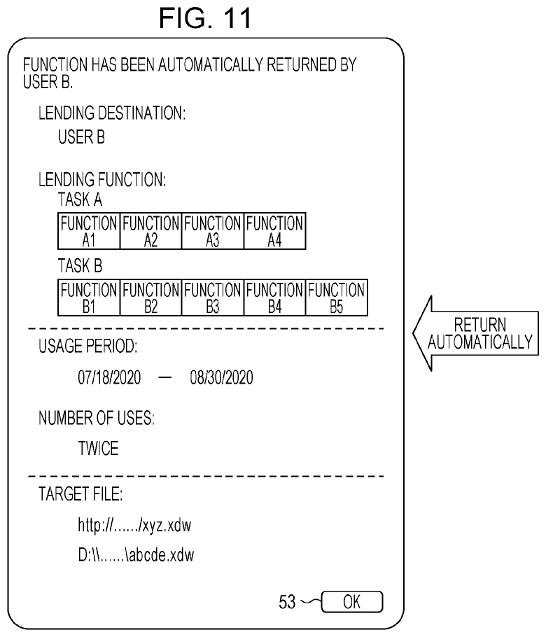

FIG. 11 illustrates an example of an automatic returning notification screen displayed on the user terminal apparatus 10 used by the user A as the lender of the function when the returning processor 213 automatically returns the function in response to the detection of the event matching the returning condition. Since the returning of the function is automatically performed, the user terminal apparatus 20 is free from displaying any indication at the automatic returning. Alternatively, a notification of the automatic returning may be made.

When the lending processing unit 11 receives the notification of the automatic returning from the user terminal apparatus 20, the UI unit 12 displays an automatic returning notification screen in FIG. 11 in response to an instruction from the lending processing unit 11. The automatic returning notification screen displays the lending condition when the function is lent to the user B. Since the lent function is returned together with the notification of the automatic returning, the lending processing unit 11 stores the received function on the memory 13.

The function may be returned in response to an operation of the user B rather than automatically. Specifically, the function returning is manually performed. The manual function returning has been described with reference to FIGS. 3A and 3B and the discussion thereof is not repeated herein. The case different from the case in FIGS. 3A and 3B is described herein.

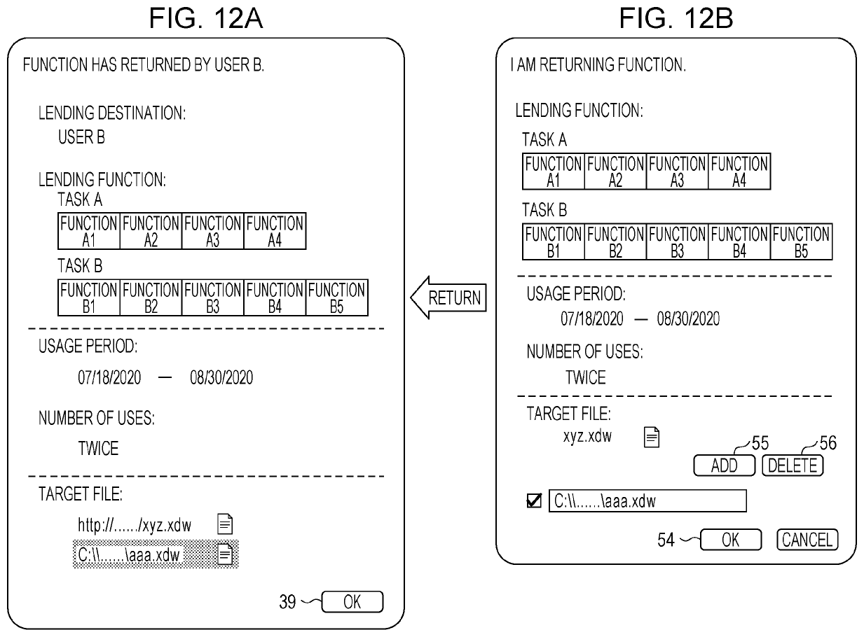

FIGS. 12A and 12B illustrate an example of screens respectively displayed on the user terminal apparatuses 10 and 20 in accordance with the exemplary embodiment when the lend function is returned.

To return the functions A1 through A4 and the functions B1 through B5, the user B performs a predetermined operation on the user terminal apparatus 20. In response to the predetermined operation, the returning processor 213 display a returning screen in FIG. 12B on the UI unit 22. After verifying the function to be returned on the returning screen in FIG. 12B, the user B selects an OK button 54. In response to the selection operation, the returning processor 213 returns the lent function and a target lent file (“wxz.xdw” in FIG. 12B) together with the notification of returning the function. The lent file is returned herein. Alternatively, the returning processor 213 may return storage destination information indicating a storage destination of the file to be returned and the user terminal apparatus 10 may retrieve the file to be returned by referencing the storage destination information.

If a file is produced as a product resulting from executing the function, the user B includes the produced file in the files as a return target and then returns the resulting files. For example, the user B includes the produced file in the target files by adding the produced file using an add button 55. By operating a delete button 56, the user B may exclude the file from the target files.

The user B selects the OK button 54 after verifying the function as a returning target and the target file on the returning screen in FIG. 12B. In response to the selection operation, the returning processor 213 transmits the lent function and the target file together with the notification of returning the function.

When the user terminal apparatus 10 receives the notification of returning the function from the user terminal apparatus 20, the lending processing unit 11 displays the returning notification screen in FIG. 12A on the UI unit 12. The user A thus learns that the lent functions A1 through A4 and the lent functions B1 through B5 have been returned. The user A also learns that documents “xyzz.xdw” and “aaa.xdw” have been received. Referring to FIG. 12A, the file may be labeled with a pattern to indicate that the file has been added by the lending destination. The exemplary embodiment is not limited to this pattern labeling. For example, the added portion may be displayed in a display attribute, such as a display color, different from the display color of the non-added portion.

When the user A selects an OK button 39, the lending processing unit 11 stores the functions A1 through A4 and B1 through B5 received together with the notification. The storage timing on the memory 13 may be triggered when the notification is received. The target file may be stored in associated with the functions A1 through A4 and B1 through B5 received together with the notification on the memory 13.

Return control of the function of the exemplary embodiment is described in detail below. The return control is related to how the function is returned in response to the occurrence of an event that is detected as the end of the operation related to the lent function. As previously described, the returning controller 21 performs the function returning automatically or in response to the manual operation of the user B. Both function returning ways are acceptable.

In the return control of the exemplary embodiment, the function is returned if an event matching the lending condition set at the lender (namely, the returning condition at the lending destination) occurs.

Specifically, when a typical event occurs, for example, the present time reaches the end of the usage period set as the lending condition, the returning controller 21 returns all the lent functions.

The returning timing monitoring unit 212 continuously monitors the execution status of the lent function. When the number of uses of each of the lent functions reaches the number of uses set in the lending condition, the returning controller 21 determines that the execution of all the lent functions has been complete. Specifically, the returning controller 21 detects the end of the execution of the lent functions and returns the lent functions. If the number of uses is not set in the lending condition, the process assumes that the number of uses set by the user A is one.

A target file may be set in the lending condition. When the end of the execution of the function on the target file is detected, the returning controller 21 performs return control to return the function, based on the assumption that an event matching the returning condition has occurred.

If the end of the operation related to a predetermined function from among multiple functions is detected, the returning controller 21 may return the function. The predetermined function may be set as a lending condition at the lender or as a returning condition at the lending destination. Alternatively, the predetermined function may be set at an initial setting without setting the predetermined function as the lending condition. The functions described at paragraphs (1) through (7) correspond to the predetermined function.

(1) If the number of uses of each of the lent functions reaches the number of uses set, the execution of all the lent functions is assumed to end. The function that has been executed last by the number of uses n (n is a natural number) may be determined to be the predetermined function.

(2) The user terminal apparatus 20 is assumed to have received the detail of the execution of the lent function together with the notification of lending the function. If a function selected for the user B to execute is a function to notify the lender of the end of the execution of multiple lent functions, the returning controller 21 automatically returns the function after the execution of the function. For example, such functions include a function to notify the lender of a work report and a function to place a work request to another worker. These functions are typical examples of the predetermined function.

(3) Multiple functions included in a task may have an order of execution. In such a case, the functions are arranged in the order of execution. Referring to FIGS. 2A and 2B, the function A1 at the head of the arrangement is to be executed first and the function A4 at the end of the arrangement is to be executed last. When the function A4 of the lent functions A1 through A4 is executed, the returning controller 21 returns the functions A1 through A4 automatically regardless of whether the user B has executed a function that is not the last function. Specifically, the function A4 located at the end of the functions A1 through A4 sequentially processed from the head corresponds to the predetermined function.

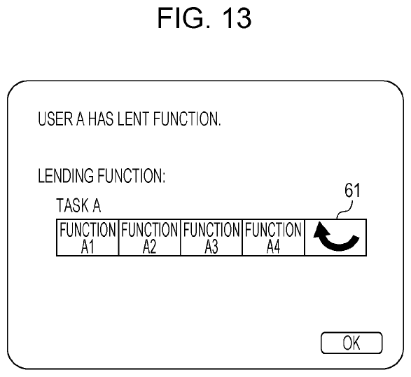

(4) FIG. 13 corresponds to FIG. 2B and illustrates an example of a lending notification screen displayed on the user terminal apparatus 20 when a lending notification of a function has been received. In comparison with FIG. 2B, the lending notification screen in FIG. 13 clearly displays a return button 61 serving as a return command button at the end of the arrangement of the lending functions. Upon receiving the notification of lending the function, the returning controller 21 displays on the UI unit 22 the lending notification screen with the return button 61 attached at the end of the lent functions A1 through A4. If the return button 61 is selected, the returning controller 21 returns the function in response to the selection operation of the user B regardless of whether the user B has performed all the functions A1 through A4.

(5) The user A may now set the lending condition that specifies one of the lent functions as a final execution function. The user terminal apparatus 20 receives information indicating one of the lent functions as the final execution function together with the notification of lending the function. When the user B has executed the final execution function, the returning controller 21 automatically returns the functions in response to the end of the execution of the final execution function regardless of whether all the functions have been executed.

(6) A point may be gained in response to each of the lent functions. When the user terminal apparatus 20 executes a function, the point imparted to that function is added. When the sum of the points reaches a threshold, the returning controller 21 automatically returns the function.

(7) If illegality in a function stored on the memory 23 or illegality in information associated with the function is detected, the returning controller 21 may automatically return the function. For example, the illegality may include the execution of the function by a third party (namely, a person other than the user B) or an attempt by a third party to execute the function, unauthorized access to or tampering of information, such as a file associated with the function.

In the discussion above, the function is returned at the timing when the execution of the function ends. The function returning timing is not limited to the end of the execution of the function. For example, the function may be returned when the function is selected or when an error occurs during the execution of the function. Alternatively, the user A may set the function returning timing on the lending screen.

As described above, according to the exemplary embodiment, the function lent from the user A to the user B is returned. The exemplary embodiment may be applicable when the user B may continuously use the lent function. The following discussion relates to a special operation of the lending and returning.

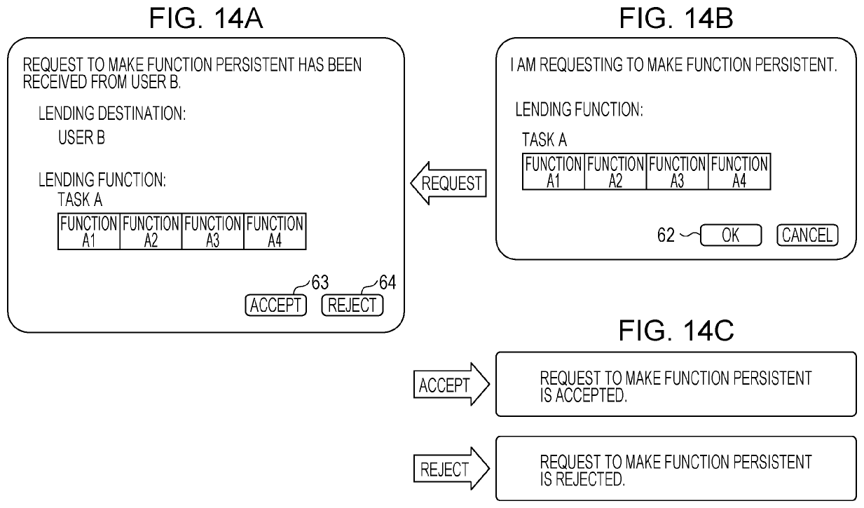

FIGS. 14A through 14C illustrate an example of screens respectively displayed on the user terminal apparatuses 10 and 20 when the lending destination requests the lender to make the lending of the function persistent. If the user B performs a predetermined operation on the user terminal apparatus 20, the UI unit 22 displays a persistence request screen in FIG. 14B. When the user B selects an OK button 62 on the persistence request screen in FIG. 14B after verifying a function to request for persistence on the persistence request screen, the returning controller 21 transmits in response to the selection operation the notification of requesting for the function persistence to the user terminal apparatus 10 used by the user A. Identification information on the function (for example, the name of the function) serving as the target of the persistence request is attached to the notification.

According to the exemplary embodiment, all the lent functions are targets of the persistence request. Referring to FIGS. 5 and 6, an interface to select the function serving as the target of the persistence request may be provided.

When the user terminal apparatus 10 receives the notification of requesting to make the function persistent is received from the user terminal apparatus 20, the lending processing unit 11 displays a notification screen in FIG. 14A on the UI unit 12. The user A thus learns that the user B intends to continuously use the lent functions A1 through A4.

The user A selects an accept button 63 to accept the function persistence request by the user B who has requested to make the function persistent. The user A selects a reject button 64 to reject the function persistence request from the user B. If one of the buttons 63 and 64 is selected, the lending processing unit 11 notifies the user terminal apparatus 20 of the intention of the user A who has selected the button. Upon receiving the notification indicating the intention of the user A, the returning controller 21 displays on the UI unit 22 the intention of the user A responsive to the function persistence request in FIG. 14C.

If the user A rejects the function persistence request from the user B, the user B returns the function at the timing matching the returning condition. On the other hand, if the user A accepts the function persistence request from the user B, the function serving as a persistence target is to reside on both of the user terminal apparatuses 10 and 20 and an operation procedure is thus to be performed to make sure that the function resides on the user terminal apparatuses 10 and 20.

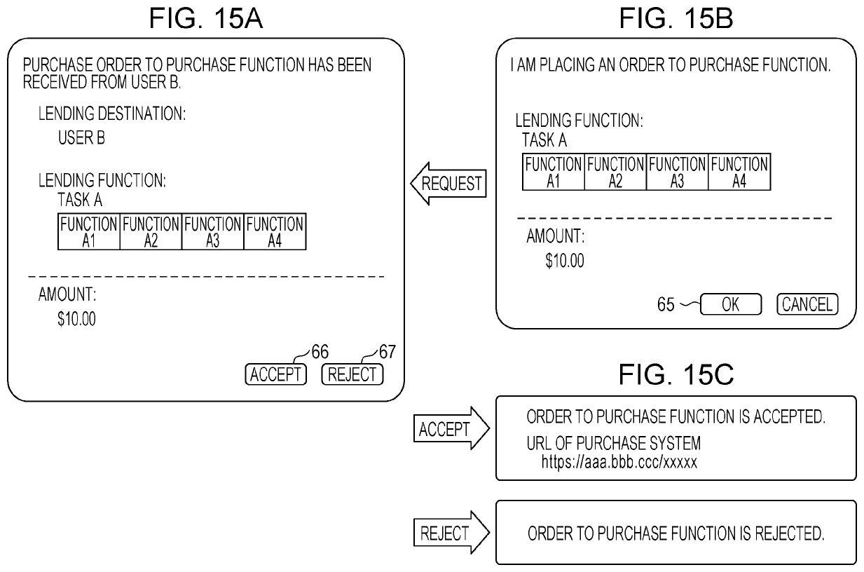

FIGS. 15A through 15C illustrate another example of screens respectively displayed on the user terminal apparatuses 10 and 20 when the lending destination requests the function persistence. FIGS. 15A through 15C are different from FIGS. 14A through 14C in that FIGS. 15A through 15C indicate an amount of money. Referring to FIG. 15C, if the user A accepts a purchase order from the user B, information on the retailer is appropriately displayed.

According to the exemplary embodiment, the function implemented as a content by a program has been described. The disclosure is not limited to the exemplary embodiment.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to return a content to a lender of the content when an end of an operation related to the content lent to a lending destination is detected.

2. The information processing apparatus according to claim 1, wherein the processor is configured to return a plurality of contents in bulk if the contents are lent and the end of the operation related to a predetermined content among the contents lent to the lending destination is detected.

3. The information processing apparatus according to claim 2, wherein the predetermined content notifies the lender of the end of the operation related to the lent contents.

4. The information processing apparatus according to claim 2, wherein the predetermined content is an end content of the contents if the contents are successively processed starting with a start content of the contents.

5. The information processing apparatus according to claim 2, wherein the predetermined content is processed last among the contents.

6. The information processing apparatus according to claim 2, wherein the predetermined content provides an content return instruction.

7. The information processing apparatus according to claim 1, wherein the end of the operation related to the content corresponds to a predetermined number of uses of the content.

8. The information processing apparatus according to claim 1, wherein the processor is configured to return the content to a file if the file is specified in lending the content and the end of the operation related to the content is detected.

9. The information processing apparatus according to claim 8, wherein the processor is configured to, when the content is returned, transmit to the lender of the content a file that is produced when the operation related to the content is performed.

10. The information processing apparatus according to claim 2, wherein a detail of the operation related to the predetermined content is modified in response to a setting modification performed by the lender of the content or in response to a request from the lending destination to the lender.

11. The information processing apparatus according to claim 1, wherein the processor is configured to, if a request to suspend lending is received from the lender of the content, return the content regardless of whether the end of the operation related to the lent content is detected.

12. The information processing apparatus according to claim 1, wherein the processor is configured to, if illegality of the content is detected, return the content regardless of whether the end of the operation related to the lent content is detected.

13. A non-transitory computer readable medium storing a program causing a computer to execute a process for processing information, the process comprising returning a content to a lender of the content when an end of an operation related to the content lent to a lending destination is detected.

14. An information processing apparatus comprising means for returning a content to a lender of the content when an end of an operation related to the content lent to a lending destination is detected.
